(19) United States
(12) Patent Application Publication
(10) Pub. No.: US 2007/0274330 A1
(43) Pub. Date: Nov. 29, 2007

(54) Network Bridge

(76) Inventors: Stephan Lietz, Bad Salzdetfurth (DE); Thomas Eymann, Hildesheim (DE); Christoph Kunze, Sibbesse (DE)

Correspondence Address: KENYON & KENYON LLP, ONE BROADWAY, NEW YORK, NY, 10004, US

(21) Appl. No.: 10/583,480

(22) PCT Filed: Nov. 19, 2004
(86) PCT No.: PCT/EP04/53013

§ 371 Date: May 17, 2007

(30) Foreign Application Priority Data
Dec. 20, 2003 (DE) 103 60 210.0

(51) Int. Cl. H04L 12/28

(52) U.S. Cl. 370/402; 370/401

(57) ABSTRACT

In a network bridge, means are provided for monitoring the contents and/or volume of incoming and/or outgoing data that are flowing through the network bridge or its memory. The means can be configurable and/or controllable by a higher-level instance, or can be predefined.

### FIELD OF THE INVENTION

The present invention relates to a network bridge, in particular for coupling IEEE 1394 buses.

### BACKGROUND INFORMATION

Networks conforming to IEEE 1394 are made up, as shown in FIG. 1, of a number of nodes K1 . . . Kn in the network, the theoretical maximum number of which is limited to 63 by the length of the corresponding node ID. The node ID for addressing the individual nodes has a length of 6 bits; the address 0×3F is reserved as a broadcast address. If it is desired to connect more than 63 nodes, the possibility exists of connecting multiple separate buses via a bus bridge. These buses can in turn be individually addressed via a bus ID. The bus ID has a length of 10 bits, corresponding to 1,024 buses. The address for “system-wide broadcast” is reserved, so theoretically 1,023×63=64,449 nodes can be connected into one network system.

A serial bus conforming to IEEE 1394 supports the transfer of asynchronous and isochronous data. Whereas the reception of asynchronous data packets must be acknowledged by the receiving nodes in order to ensure reliable data transfer, no acknowledgment is necessary for isochronous data. Bus bridges for coupling multiple buses must support the transfer of both data types. At the same time, they must ensure that in more-complex topologies each data packet can reach its receiver, and that all the buses connected into the network system run on a synchronized cycle. Draft Standard IEEE 1394.1 version 1.04 specifies the functionality of such a High Performance Serial Bus Bridge, specifically for use in networks conforming to IEEE 1394 b.

### SUMMARY OF THE INVENTION

The network bridge having means for monitoring the contents and/or volume of incoming and/or outgoing data that are flowing through the network bridge or its memory, in which context the means for monitoring the contents and/or volume are embodied controllably and/or configurably by a higher-level instance, allows the data contents and/or data volume to be monitored or supervised by the network bridge.

The means for monitoring the contents and/or volume can be made up of a software component that can easily be inserted into the network bridge architecture and has a gateway and/or firewall functionality. The contents and/or volume of the incoming and outgoing data that are flowing through the network bridge or its memory can thereby be supervised.

### BRIEF DESCRIPTION OF THE DRAWINGS

FIG. 1 shows networks conforming to IEEE 1394.

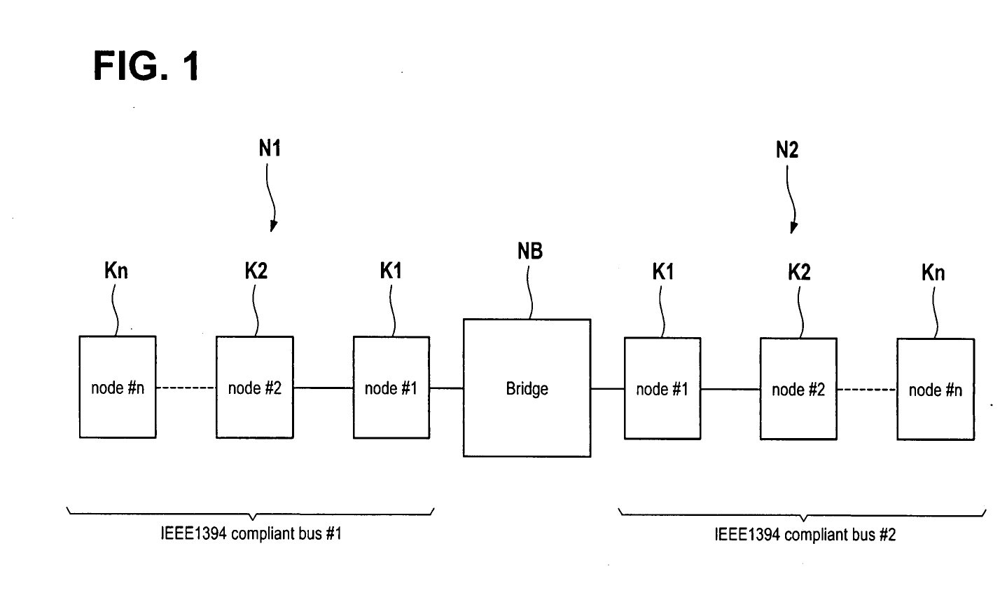

FIG. 2 shows an architecture model for a network bridge according to the present invention.

FIG. 3 shows the control system for the network bridge-gateway-firewall functionality.

FIG. 4 shows an alternative implementation.

### DETAILED DESCRIPTION

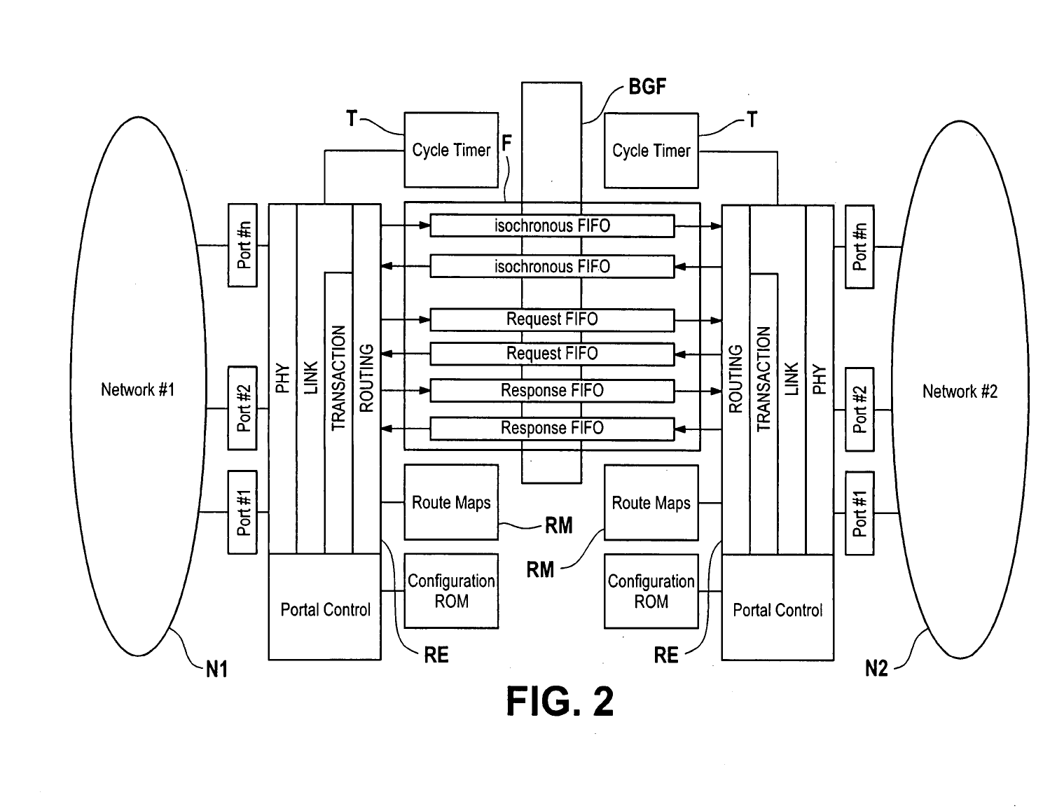

For better comprehension, the manner of operation of an architecture model for a network bridge according to IEEE 1394 Draft Version 1.04 will first be presented, before the actual invention is described. The network bridge shown in FIG. 2 is connected via its respective ports P1, P2, . . . Pn to two independent networks N1, N2, and can receive and transmit data. In general, it will receive data from one network and transmit it into the other network. The “Port,” “Configuration ROM,” “PHY,” “LINK,” and “TRANSACTION” functional blocks correspond to those of a standard network node conforming to IEEE 1394. The network bridge additionally possesses routing maps RM and a routing unit RE for each of the two networks. Information about the topology and node addresses in the respective networks is kept in routing maps RM; and via routing unit RE, data can be exchanged between LINK or TRANSACTION and memory F of network bridge NB. According to IEEE 1394.1, memory F is made up of a number of individual FIFOs which temporarily store data that are to be transported from one bus to the other. The network bridge additionally possesses an internal timer T (“Cycle Timer”) which allows it to synchronize the cycles in the two buses.

Routing units RE, as well as the “Port,” “Configuration ROM,” “PHY,” “LINK,” and “TRANSACTION” functional blocks, are controlled via the portal control (PC) functional units.

Memory F of the network bridge possesses, according to the present invention, a network bridge-gateway-firewall functionality BGF with which the contents and/or volume of the incoming and outgoing data that are flowing through FIFO memory F are monitored. The two upper memory regions are reserved for isochronous data. Two Request memory regions and two Response memory regions are provided for asynchronous data.

Monitoring of the contents and/or volume is accomplished by the higher-level instance BGF, or is predefined.

The checking and control of the data makes possible access controls or even a variety of filter functions, e.g. packet filters, for the data flow from one bus segment via the network bridge to the next bus segment. This is the basis for secure and protected data transfer via the network bridge. Specifically, the “bridge-gateway-firewall functionality” offers protection from undesired connections, e.g. hacker attacks, or prevents confidential data from being exchanged without permission via the network bridge. The network bridge-gateway-firewall functionality can be configured, and acquires the requisite information, via suitable software interfaces from a higher-level instance, e.g. a software layer having management and configuration responsibilities. It is additionally possible to individually configure the network bridge-gateway-firewall functionality of each specific network bridge. In other words, each network bridge is capable, independently of the others, of performing one or more or no functions of a gateway or firewall.

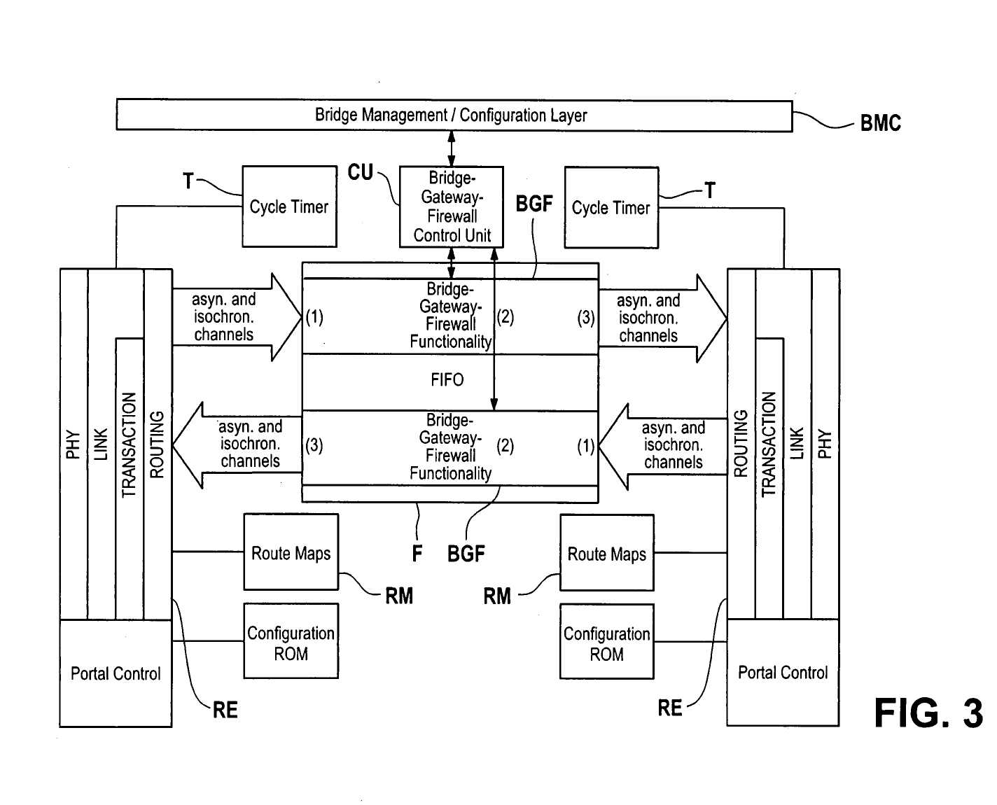

The network bridge-gateway-firewall functionally can encompass, for example, a so-called control unit CU and a network bridge-gateway-firewall functionality (module BGF in FIG. 3), which makes it possible to analyze and manipulate the data (contents and volume) flowing through memory F of the network bridge. Analysis of the data can be accomplished on various levels, in particular in various layers of the OSI reference model. In other words, on the lowest (physical) level the 1394 packet information can be checked; however, not only the 1394 header, but also the contents of the useful data can be closely analyzed. This includes the data from higher layers, for example IP data, as far up as data of the application layer and user data. The extent of the possible data analysis is, in particular, scaleable, since it is correlated with the time required therefor, which in turn depends on the computing power of the processor. In other words, there are, for example, various filter rules, and these in turn are configurable. Configuration of these filter rules and of the entire functionality of the network bridge-gateway-firewall can be effected from a higher-level software layer, e.g. management and configuration layer BMC.

One possible access to the data takes place at a time (1) when the data are being written into FIFO memory (2). They remain there until the network bridge-gateway-firewall has processed the data and then releases them (3). This type of implementation can be used if the data analysis by the network bridge-gateway-firewall functionality is limited to the quantity of data that can be temporarily stored in the FIFO. One example of this is the address function (source and target address): the network bridge-gateway-firewall control unit CU scans the data packets in the FIFO for specific IP addresses that are stipulated by configuration of the network bridge-gateway-firewall, and blocks communication from or to those specific addressees. Another example is blocking or prioritization of specific input and output interfaces, for example the respective PHY ports. A further example is the logging function of the network bridge-gateway-firewall: with this function, all of the data traffic through the network bridge can be logged. In other words, the network addresses and/or node addresses of the packets passing through the network bridge are recorded in a table or a log file, and at certain intervals are transmitted to another function block such as, for example, Bridge Management BMC, or to a specific node that selects the data.

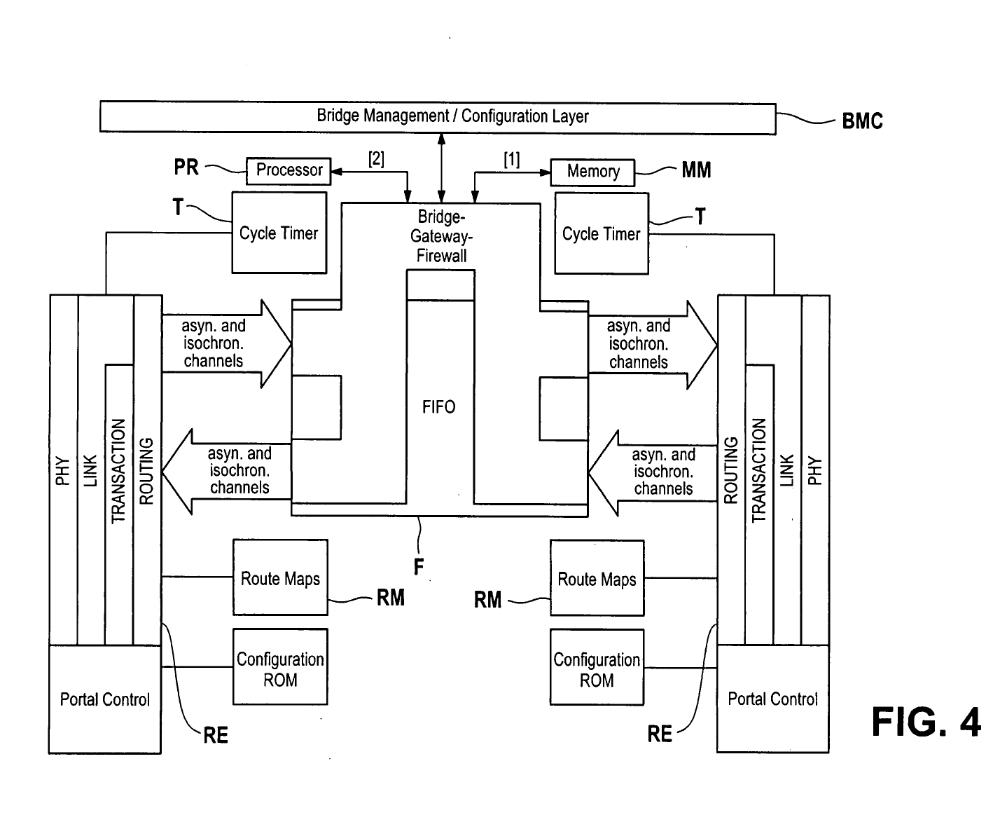

FIG. 4 shows a slightly different configuration for implementation of the network bridge-gateway-firewall. Here it is apparent that the entire data flow through the network bridge also flows through the “bridge-gateway-firewall.” This is necessary if the data analysis extends to multiple packets which cannot be stored simultaneously in the FIFO; or if analysis of the useful data requires more time, and additional buffers (memory MM) or more computing power (processor PR) are needed.

For possible monitoring of the data volume, the network bridge-gateway-firewall can, for example, for a specific period of time—which can be defined at any time by configuration from outside, i.e. from any specific node in the network or from the BMC—interrupt transfer of the isochronous channels and, as regards transfer of the asynchronous channels, control the data flow so that each individual node is permitted only a specific number of data transfers. Once that number has been reached, further data are ignored by the network bridge-gateway-firewall.

Interaction of the individual functional blocks within the network bridge occurs via interfaces through which data can be read and/or written. By way of one such interface, management/configuration layer BMC, which can be embodied in hardware or software, can manipulate statistical data, useful data, or parameters for operation of the functional blocks. The collection of a variety of data makes it possible for the software layer to quickly prepare statistics about the current operation of the network bridge. Those data can in turn be used to optimize the operation of the functional blocks, for example by modifying parameters of the functional blocks in particular. One example is an IEEE 1394 network in which at times predominantly isochronous data, e.g. audio and video streams, and at other times asynchronous data, are transferred. By way of statistical evaluations, management and configuration layer BMC (or software layers located above it) can recognize that the proportion of asynchronous data in the total data volume is sharply increasing. It is then possible to reconfigure flexible FIFO block F, or stipulate appropriate parameters to it for automatic reconfiguration, in such a way that the memory regions for isochronous data are made smaller, and those for asynchronous data are enlarged. As a result, the network bridge can react quickly to changes, and need not constantly keep available memory regions for isochronous and asynchronous data throughputs.

1-8. (canceled)

9. A network bridge comprising:
means for monitoring at least one of contents and volume of at least one of incoming and outgoing data flowing through at least one of the network bridge and its memory, the means for monitoring being one of (a) at least one of configurable and controllable by a higher-level instance and (b) predefined.

10. The network bridge according to claim 9, wherein the network bridge is for coupling IEEE 1394 buses.

11. The network bridge according to claim 9, wherein the higher-level instance includes at least one of a management and configuration layer for the network bridge.

12. The network bridge according to claim 9, wherein the means for monitoring encompasses a software component within a network bridge architecture, the component having at least one of a gateway functionality and a firewall functionality.

13. The network bridge according to claim 9, wherein an extent of a data analysis by the means for monitoring is scaleable.

14. The network bridge according to claim 9, wherein the means for monitoring is configured in such a way that in addition to an analysis of the data, a manipulation of the data is performed as well.

15. The network bridge according to claim 9, wherein an analysis and manipulation of the data are performable in various layers of a layer model, including an OSI reference model.

16. The network bridge according to claim 9, wherein the means for monitoring is configured to one of block and prioritize at least one of address interfaces, input interfaces, output interfaces, and logged data, on the basis of an evaluation.

17. A system comprising:
a plurality of network bridges, each of the network bridges including means for monitoring at least one of contents and volume of at least one of incoming and outgoing data flowing through at least one of the network bridge and its memory, the means for monitoring being one of (a) at least one of configurable and controllable by a higher-level instance and (b) predefined, the means for monitoring being individually configurable in each network bridge in order to allow each network bridge, independently of other of the network bridges, to be capable of performing functions of one of a gateway and a firewall.
